(19) United States
(12) Patent Application Publication
(10) Pub. No.: US 2019/0045013 A1
(43) Pub. Date: Feb. 7, 2019

(54) SYSTEM AND METHOD FOR FORMING A NETWORK WITH INTEGRATED MANAGERIAL POSITIONS AND TASK PLACEMENT

(71) Applicant: PIIIPO INC., McLean, VA (US)

(72) Inventor: Minqi WU, Falls Church, VA (US)

(21) Appl. No.: 15/722,633

(22) Filed: Oct. 2, 2017

Related U.S. Application Data
(60) Provisional application No. 62/541,662, filed on Aug. 5, 2017.

(51) Int. Cl. H04L 29/08; G06Q 10/06; G06Q 10/10; G06F 17/30

(52) U.S. Cl. CPC H04L 67/125; G06Q 10/06395; G06Q 10/1095; G06F 17/30241; G06Q 10/1053

(57) ABSTRACT

The present invention provides a professional service referral network system with integrated managerial positions executed on a central computer system and accessed from a private device. The system comprises a central APPS server software executed on the central computer system, and each network member accesses the network resources via own private device. Each member can be a customer member, a vendor member, or a marketing associate. The system enables each customer and vendor member communicate directly to enhancing efficiency, and the system also provide the marketing associates as the integrated managerial positions to promote the business mentoring and to enhance business success and customer satisfactory.

### BACKGROUND OF INVENTION

US publication application No. 20140330733 disclosed a systems and methods graphically displaying geographic data corresponding to multiple employment opportunities, such as by displaying points on a map. The system includes an employment search server that is operatively coupled to a public network, and has a database that stores data associated with a plurality of employment opportunities, and data associated with a plurality of users. The system receives employment opportunities information entered by an administrator or a potential employer, finds geographic data for the employment opportunities using a map service, and stores the geographic data in the database. When the system receives a query from a user for one or more employment opportunities, it searches the database for employment opportunities corresponding to the query, then uses the geographic data of those employment opportunities to display those employment opportunities, such as by displaying points on a map. The system may also display the location of the user on the map.

US publication application No. 20150248649 disclosed a system and methods for human resources management and efficient, online and mobile guidance on assisting job seekers in locating and securing temporary or permanent job opportunities. The system and methods perform substitute fulfillment, including identifying acceptable substitute employees/professionals, job opportunity review, real time employee availability, skill set review for employers/clients, appointment scheduling and establishing network connections amongst employers/clients and employees/professionals for both current and future job opportunities that arise in which qualified employees/professionals are paired with appropriate employers/clients whom are seeking to fill either temporary or permanent positions.

In addition, US publication application Nos. 20150248649, 2014/0279352, 2010/0125803, 2009/0157523, 2017/0046729, 2008/0195605, and 2010/0274638 are disclose some service personnel community for refereeing services. However, none of the disclosure in the publications mentioned above truly provides a network. These publications disclose a system or a platform for exchanging service information. The interaction among members, other than the interactions between service providers and their clients, is at a minimum to none. Further, the conventional so-called network or on-line community, a potential customer can only evaluate the service providers by other comments or ranking made by other members, and the only remedy for resolving any dispute is based on system provider's policy. Hence, there is a need for further enhancing on ensuring the service or product quality, and preventing any potential dispute before it occurs, or resolving any on-going concern at a more efficient and personal level.

### SUMMARY OF THE INVENTION

The present invention provides a method and a professional service referring system including a central computer system and a plurality of private devices forming a network with integrated managerial positions for task placement.

According to an aspect of the present invention, there is provided a method of forming a network with integrated managerial positions for task placement and executed on a central computer system and accessed from a private device. The method comprises providing a registration means for a potential member to register via potential member's own private device, wherein the potential member is registering as a customer membership type, a vendor membership type, or a marketing associate membership type, or combination of any thereof.

A professional service referring system for exchanging referring information between a central computer system and individual controlled private devices, and for providing integrated managerial positions, said professional service referring system comprises a membership element, comprising a customer membership type, a vendor membership type, and a marketing associate membership type, wherein each system member has one or more membership types; a managerial positions element, comprising a first-rank position, a second-rank position, and a third-rank position; a first private device for a first vendor member; a second private device for a second vendor member; a third private device for a first customer member; a payment system; said central computer system coupled to said first private device, said second private device, said third private device, and said payment system via a computer network.

The system include s a registration scheme, wherein said first private device executes said registration scheme to register said first vendor member into said central computer system, said second private device executes said registration scheme to register said second vendor member into said central computer system, and said third private device executes said registration scheme to register said first customer member into said central computer system.

The system further includes a task assigning scheme, executed by said first private device, said second private device, said third private device, and said central computer system, wherein said first private device provides a first available serving schedule with a first professional service type to said central computer system for said first vendor member; said second private device provides a second available serving schedule with said first professional service type to said central computer system for said second vendor member; said first private device provides a third available serving schedule with a second professional service to said central computer system for said first vendor member; said first private device provides a first personal schedule to said central computer system for said first vendor; said central computer system creates a final available serving schedule combining said first available serving schedule, said third available serving schedule, and said first personal schedule; said third private device creates and sends a first task related to said first professional service type to said central computer system; said central computer system forwards a final available serving schedule and said second available serving schedule to said third private device; said third private device sends directly a request for an appointment reservation for said first task to both said central computer system and said first private device; said first private device sends directly an acceptance confirmation or a rejection message to both said central computer and said third private device; said third private device confirms said acceptance confirmation when receives said acceptance confirmation and said third private device initiates a withheld payment at said payment system as a deposit; said third private device sends a request for changing appointment time or a request for cancelling appointment, when said first customer member decides to change or to cancel said appointment reservation, directly to both said central computer and said first private device before a predetermined period of time before said appointment reservation; said first private device sends directly a starting message to said central computer system and said third private device to indicate beginning proceeding said task; said third private device displays said first vendor member's current location and an estimated arrival time when said first task is performed at said first customer member's premises; said central computer system provides a security scheme to said third device and said first device to authenticate said first vendor member when said first vendor member arrives at said first customer member's premises; said first private device sends a service scope modification on said first task to said central computer and said third private device when both said first customer member and said first vendor member agree and decide to change scope of said task; said first private device sends directly a completing message to said central computer system and said third private device to indicate completing said task; third private device sends a confirmed completion massage directly to said payment system to release said withheld payment, or sends a complaint directly to said central computer system and said payment system for requesting refund or rejecting payment; said first private device sends a customer ranking message to said central computer system for ranking said first customer member; and said third private device send a vendor ranking message to said central computer system for ranking said first vendor member.

The system further comprises a managerial operation scheme for managing said managerial element executed by said central computer system, wherein each of said first customer member, said first vendor member, or said second vendor member is qualified for joining said first-rank position, comprising said central computer system tracks production of each integrated managerial position holders, wherein said production is each integrated managerial position holder's own total sales, or a total sales of a first-rank position holder, all third-rank position holders associated with said first-rank position holder, and all second-rank position holders associated with said first-rank position holder; said central computer system tracks benefits and bonus for each managerial position holder, wherein said bonus is determined by said production; said central computer tracks number of mentees each managerial position holder mentoring and number of new members referred by each managerial position holder; said central computer system sends referrals to mentee, and sending complaints against a mentee to both mentor and mentee, and sends said request wherein mentor is notified to assist mentee and to resolve dispute and to improve customer service quality; and said central computer system tracks each managerial position holder's total complaints under each managerial position holder and under each managerial position holder's mentees, wherein said central computer system signals for issuing quality recognition when said total complaints is within a predetermined complaint threshold.

In one embodiment of the invention, the private device is a desktop computer.

In one embodiment of the invention, the private device is a cellular phone.

In one embodiment of the invention, the vendor membership type further comprises a premium vendor membership and a regular vendor membership.

In one embodiment of the invention, the first vendor member is in said premium vendor membership.

In one embodiment of the invention, the private device displays a map illustrating locations of vendor members within geographical area available for providing the service or product as desired.

In one embodiment of the present invention, the system further comprises an interface for transferring or extracting available serving schedule from vendor member's a private system operating on vendor member's private device.

In one embodiment of the present invention, the system further comprises a means for filing a complaint to the central computer system in regard to any service and product received within the network.

In one embodiment of the present invention, the system further comprises a means for accumulating bonus points, and the bonus points are rewarded based on the activities that each network member has in the network, including, but not limited to, providing services or product to other network members, mentoring other members, and acquiring services and product from other network members.

In one embodiment of the present invention, the system further comprises a means for points redemption; the network member can redeem the bonus points in exchange for other services or product, or participate network gift raffle.

In one embodiment of the present invention, the system further comprises a means for points forwarding, that members can give their bonus points to another network member.

The advantages of the present invention is that the speed of the operating a task placement is faster, because the method forwarding an appointment request for said first task directly to both said central computer system and said first private device from said third device and forwarding an acceptance confirmation directly to both said central computer and said third private device from said first private device.

### BRIEF DESCRIPTION OF THE DRAWINGS

The present invention will now be specified with reference to its preferred embodiment illustrated in the following drawings.

FIG. 1 is a schematic diagram illustrating the relationship of each component of the present invention.

FIG. 2 is a flow relationship diagram illustrating the flowing process for scheduling an appointment according to an embodiment of the present invention.

FIG. 2A is a flow chart illustrating the flowing process for scheduling an appointment according to an embodiment of the present invention.

FIG. 3 is a flow chart illustrating the method that a customer member rejects payment and dispute the service performed according to an embodiment of the present invention.

FIG. 4 is a flow chart illustrating the method that a vendor member setups and operates in a private device of an embodiment of the present invention.

FIG. 5 is a flow chart illustrating the method that a customer member setups and operates in a private device of an embodiment of the present invention.

FIG. 6 is a flow chart illustrating the method that a marketing associate member setups and operates in a central computer system of an embodiment of the present invention.

FIG. 7 is a flow chart illustrating the method that a member gets reward points and redeems reward points of an embodiment of the present invention.

FIG. 8 is a flow chart illustrating the steps that a customer member gets gift code from a gift card and the steps that a customer member sends a gift code to a friend of an embodiment of the present invention.

FIG. 9 is a flow chart illustrating the method that a vendor member setups and accepts an appointment referral request according to an embodiment of the present invention.

FIG. 10 is a schematic diagram illustrating an example of a dashboard or APP on the private device of an embodiment of the present invention.

FIGS. 11A-B are a schematic diagram illustrating an example of data structure for the private device and the central computer system of an embodiment of the present invention.

FIG. 12 is a schematic diagram illustrating sub-systems for each of different functions in an embodiment of the present invention.

### DESCRIPTION OF THE INVENTION

The embodiments of the invention will be described below with reference to the drawings. It should be understood that the specific embodiments described herein are merely illustrative of the invention and are not intended to limit the invention. The figures reveal some details. It should be understood that the details of the figures may be different from those that have been disclosed in words unless explicitly limiting the characteristics in specification.

The instant invention can be implemented as either a software or/and hardware over the cloud architecture with a mash network connectivity, where functions and associated interface are executed on a main central computer system with necessary circuits and processing units, and each member accesses the functions through the associated interface from their own private devices, such as a smart phone or a computer. Each member and network administrator (such as the refund claim department or corporate functioning personnel) can also communicate directly without requiring the main central computer system as a medium for forwarding every communicating message. Each disclosed recited element and related data are implemented and stored in a database. Each scheme is implemented by either software or hardware.

One embodiment of the present invention disclosed a method of forming a network comprising of central management software executed on a central computer system and APPs or stand alone program executed on each member's private device. Such that, each member can access information and functions provided on the central computer system via own private device.

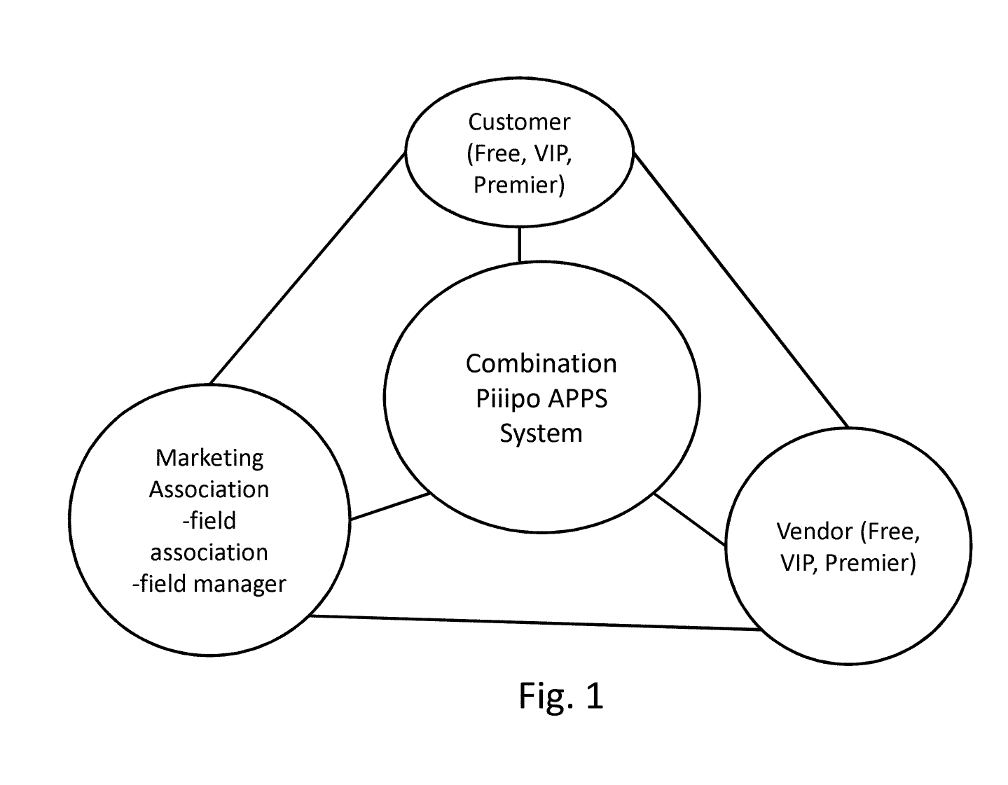

FIG. 1 provides an overall view of the present invention, which comprises four components interconnected in forming the network, a central computer system (PIIIPO Apps system, naming after current Assignee) and three different types of members: customer member, vendor member, and marketing associates. Each member will use own private devices to communicate with the central computer system (PIIIP Apps system) or to communicate directly with other members.

Each member communicates within the network by their private devices. Each of the four components can either directly communicate with each other, or go through the central computer system. Each component communicates with one another via a network, such as Internet.

The private device can be a cellular phone, a computer, or other suitable electronic communication devices. The private device communicates with the central computer system via an APP, or stand along executable software, or a web browser.

As shown in the FIG. 1, each of members can directly communicate with the central computer system, for searching other members' information and also upload one's own information, such as the personal profile, company profile, service location, and provided services and good available for sale. One can also enter or upload his/her own available schedule into the central computer system for potential clients within the network to consider when any potential client is seeking the services and booking for appointments. Both the membership schemes and the schedules are implemented and stored in a database.

The central computer system also provides an interface or API (application program interface) for data uploading. Often time each network members may have their own private managing system for tracking the appointment schedule. Network member can use such API to upload data or to synchronize schedules between the central computer system and member's own private system.

Further, each member can have multiple schedules to support multiple professions in combining with personal/non-profession related schedule. Such that the central computer system can consolidate every schedule into one final schedule for other members to consider while members conduct transactions with each other.

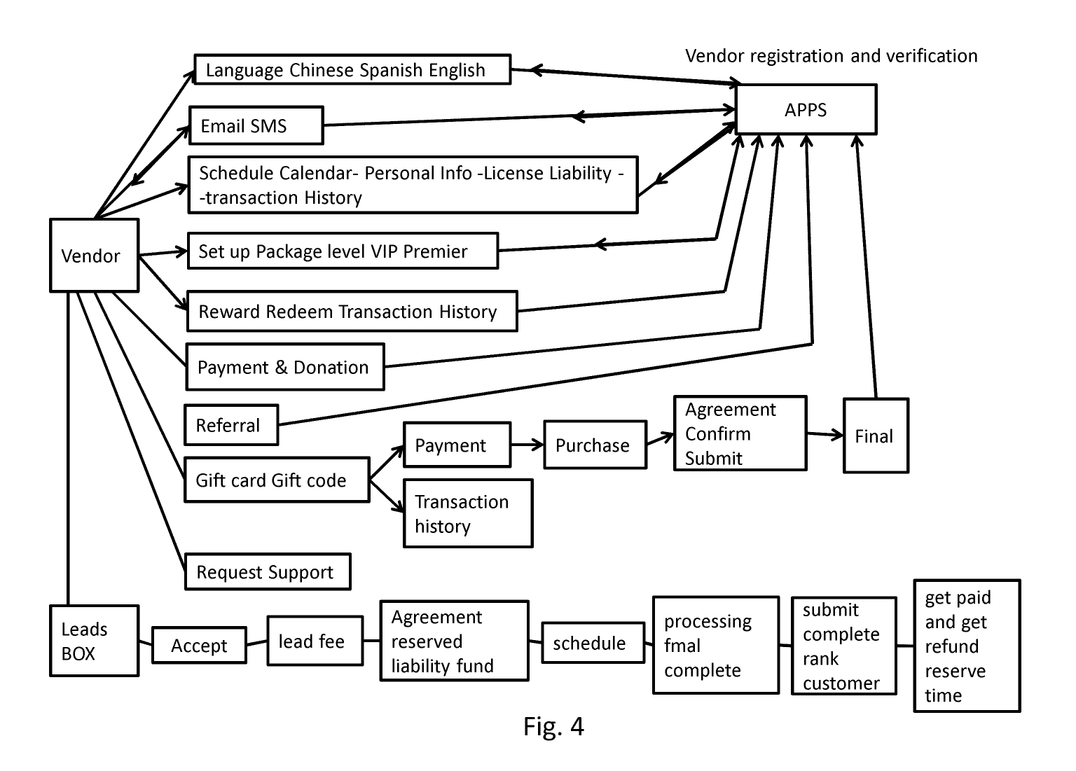

The method comprises providing a registration means for a potential member to register via potential member's own private device. The central computer system provides a registering interface, which any qualified interesting party can access over a network/internet via their private device, such as a personal computer or cellular phone, to register and join the network. FIGS. 4-6 provide a standard protocol and information required to be entered into the central computer system for registration.

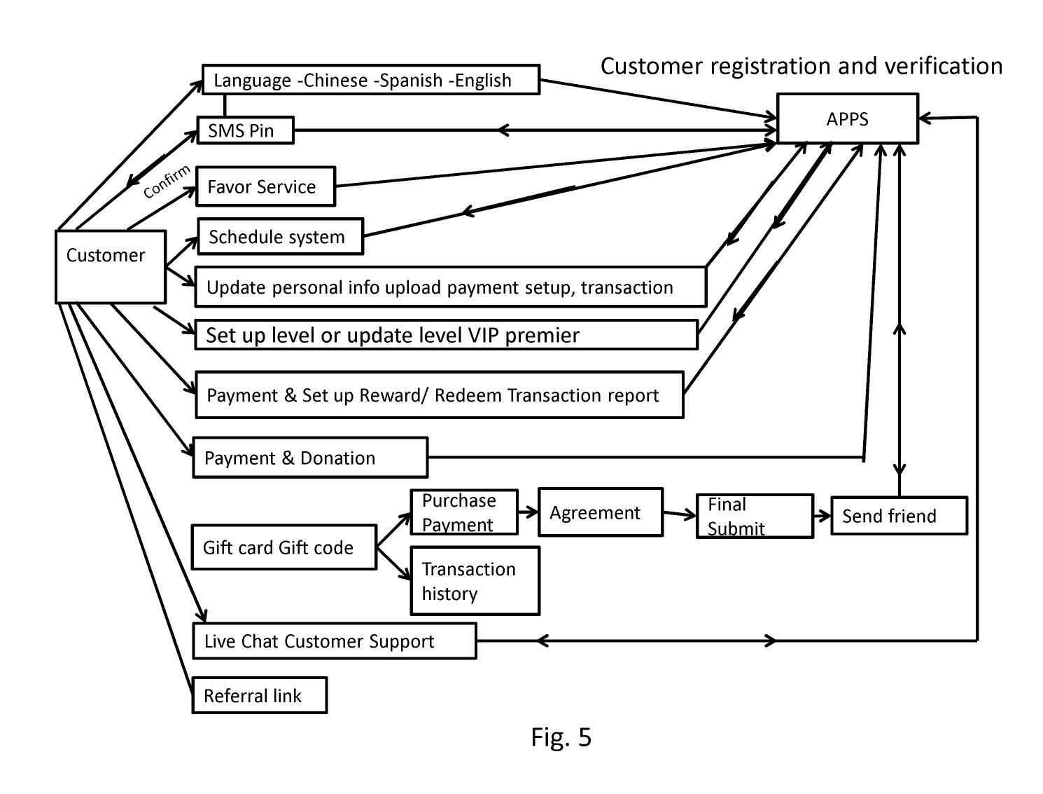

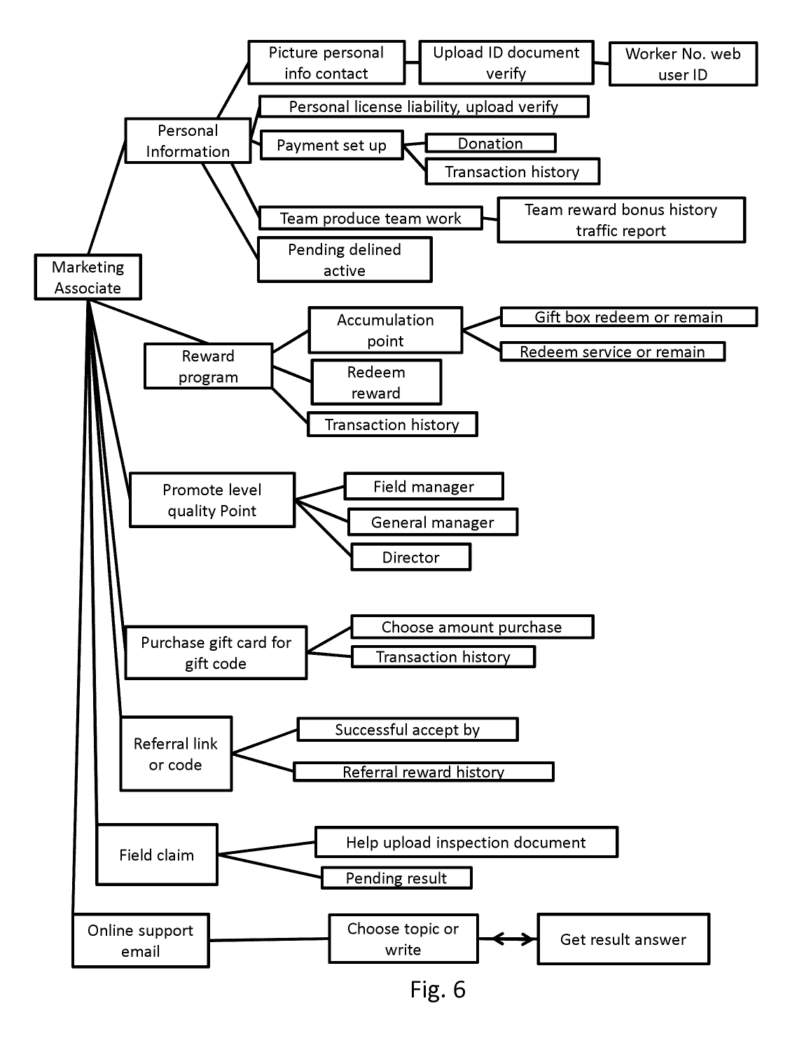

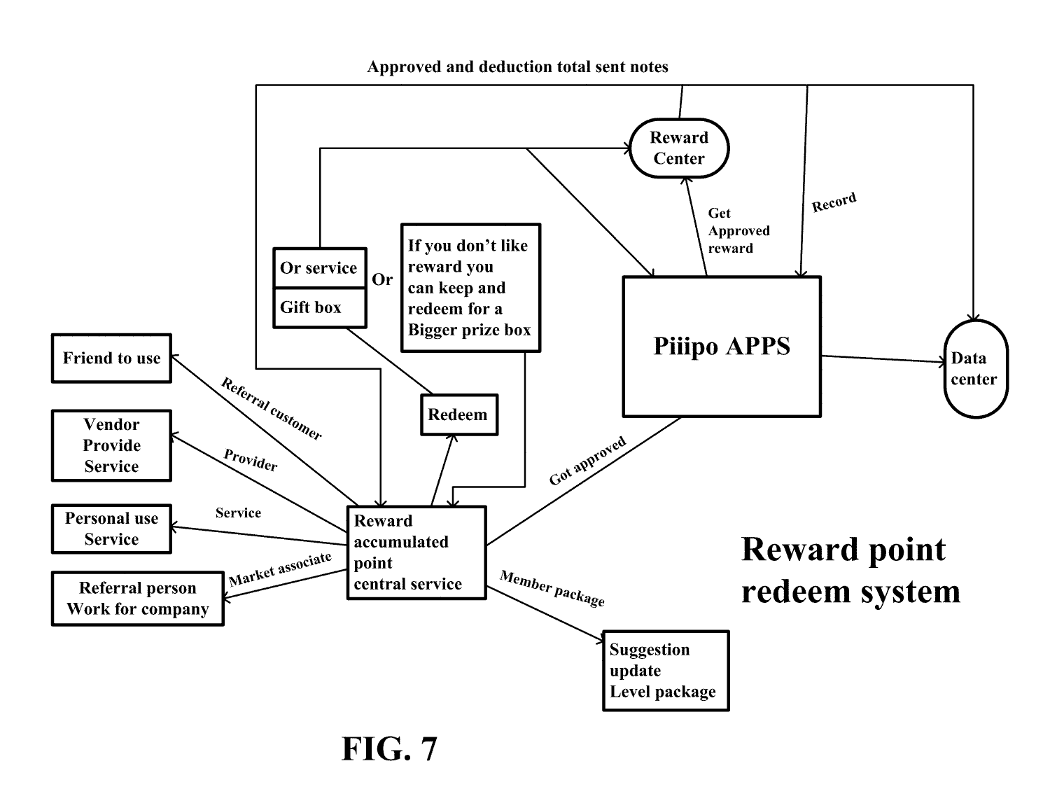

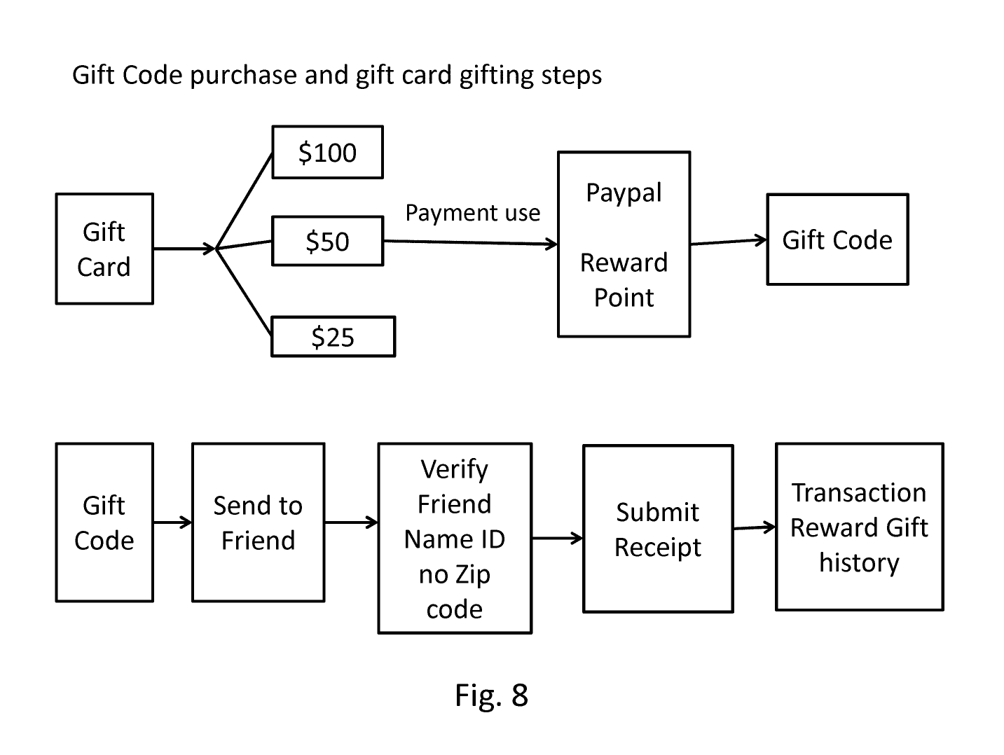

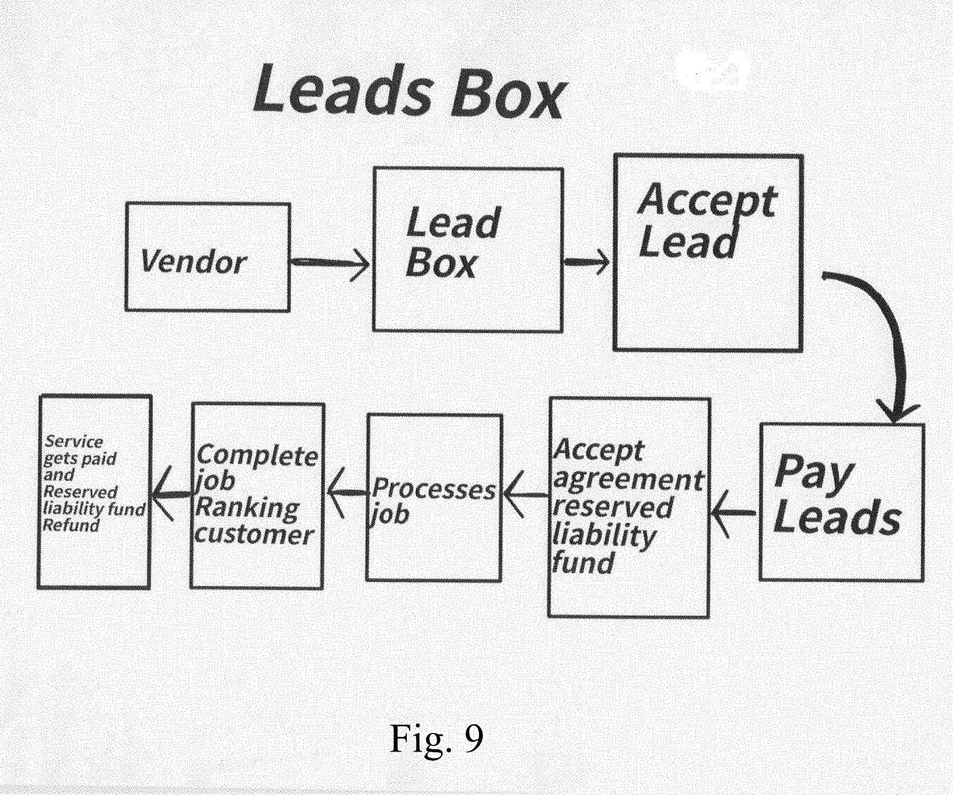

There are three main membership types that a potential member can register: a customer membership type, a vendor membership type, and a marketing associate membership type. A potential member can also register for more than one membership type. FIG. 4 shows the registration information and steps for registering as a vender member. FIG. 5 shows the registration information and steps for registering as a customer member. FIG. 6 shows the registration information and steps for registering as a marketing associate member.

In one embodiment of the present invention, the vendor membership type further comprises a premium vendor membership and a regular vendor membership. In one embodiment of the present invention, the vendor membership type further comprises an additional a VIP vendor membership. Different membership provides different or additional benefit. The premium and VIP memberships will enjoy higher exposure to potential customers, and higher referral rate from other referees.

In one embodiment of the present invention, the customer membership type further comprises a premium customer membership and a regular customer membership. In one embodiment of the present invention, the customer membership type further comprises an additional a VIP customer membership. Different membership enjoys different functions and benefit within network. For instance, a higher customer membership may have a higher reservation preference when competing again another customer for booking a schedule.

Different vendors may provide different professional services. The professional service types are the work categories. For example, the categories can include professional services including tax, accounting, insurance services, legal counsel, real state, financial advisor, business consultation, travel agency, recruiting service, or messages for employment opportunities. The categories can also physical related or life services, such services as provided by doctors and dentists. The categories can also include learning, education, child cares, sports coaching, and personal health training, and so on. The present invention is not limited thereto.

In one embodiment of the present invention, the marketing associate membership type further comprises a first rank, a second rank, and a third rank. The marketing associate membership type provides each member an opportunity to hold a managerial position within the network.

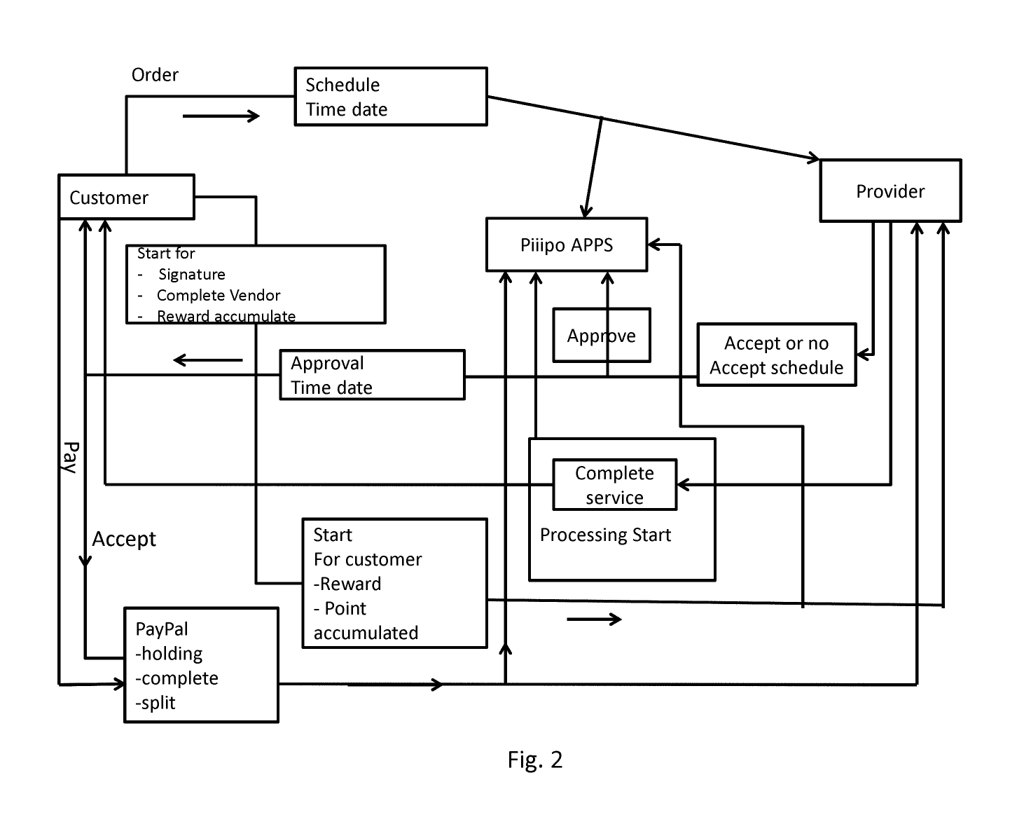

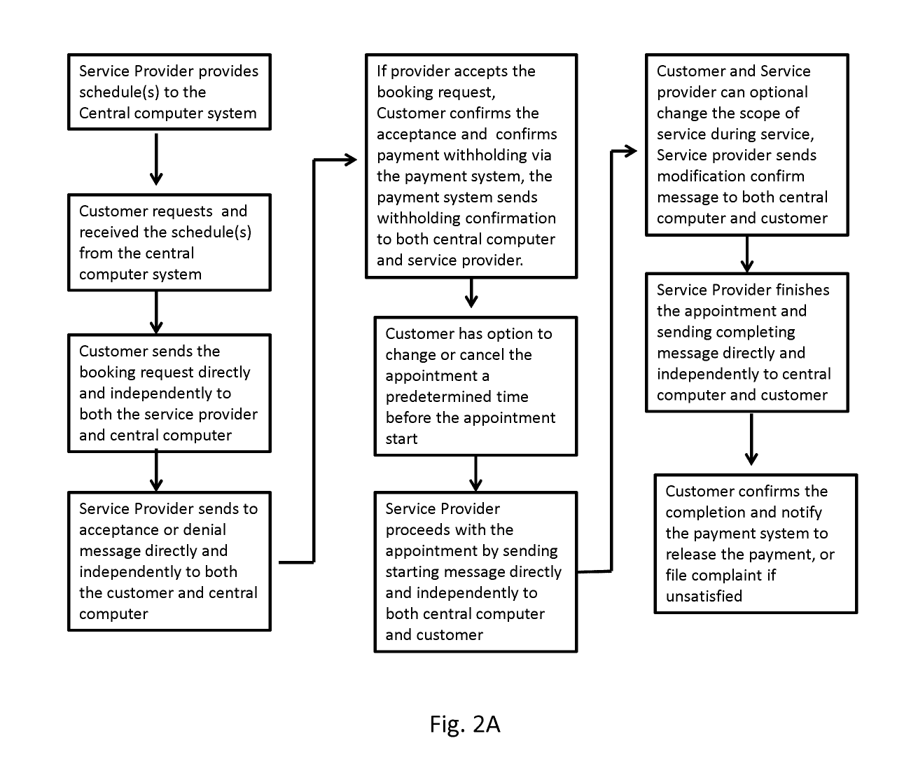

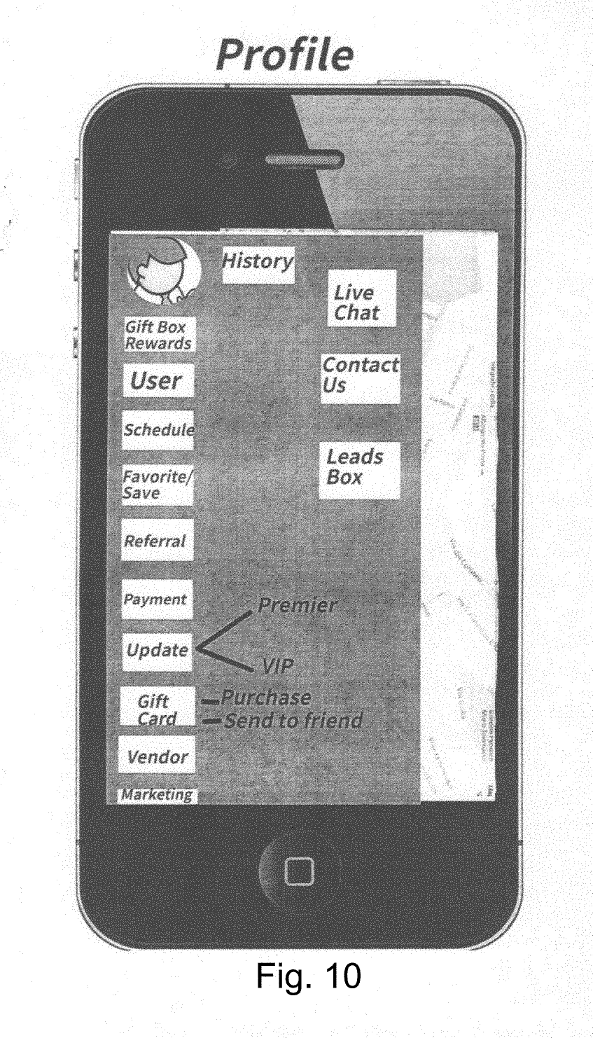

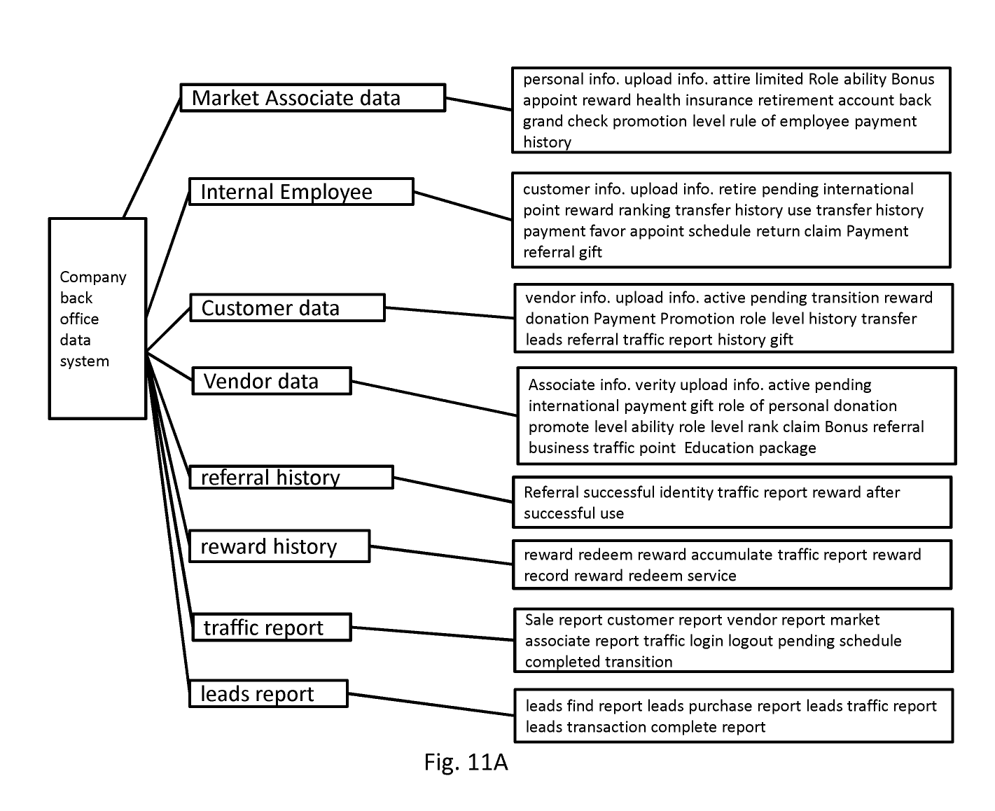

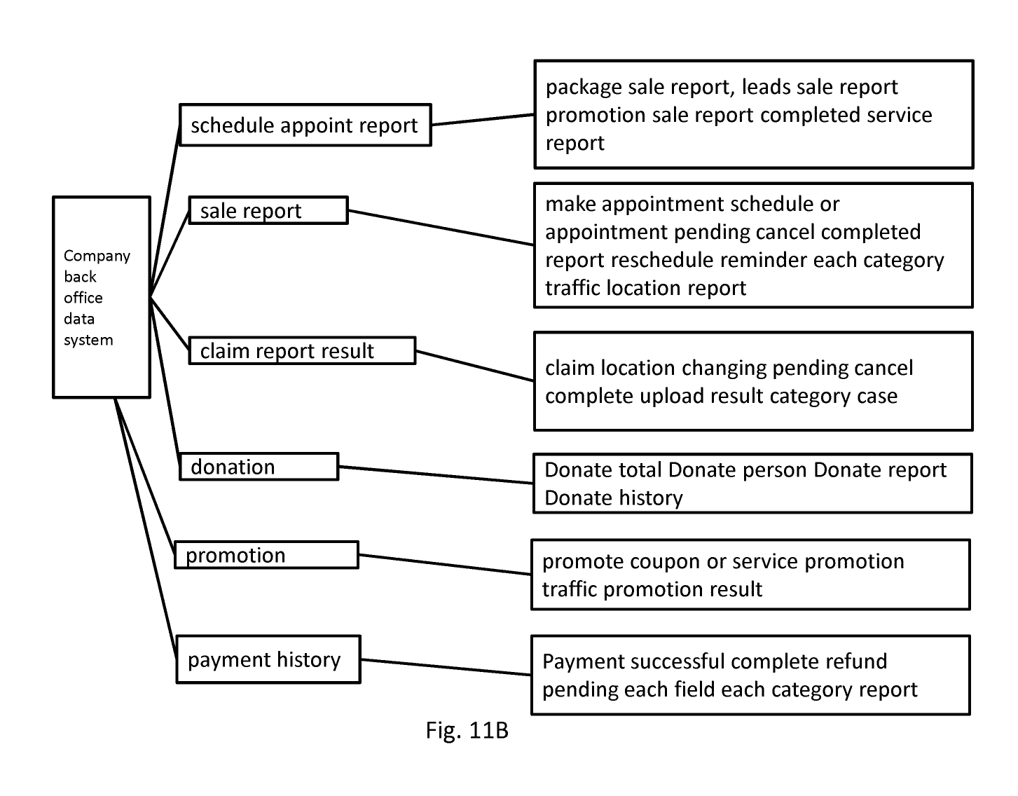

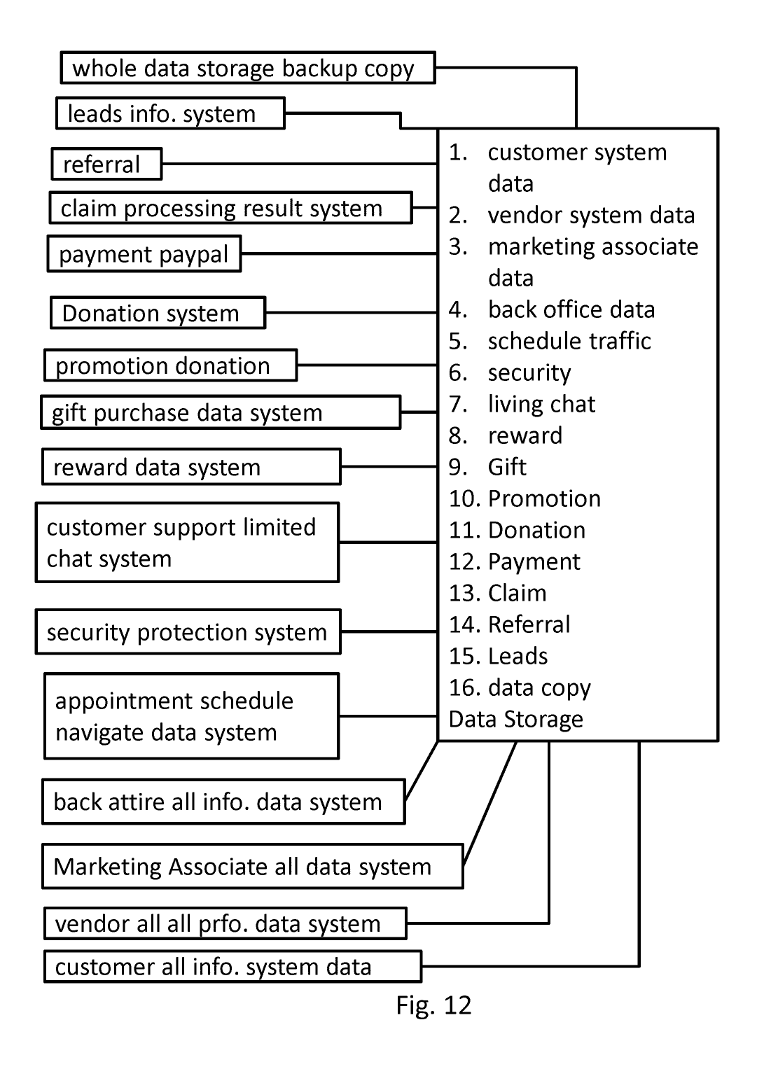

Please refer to FIGS. 2-2A and FIG. 10, the FIGS. 2-2A illustrates flowing process for scheduling an appointment after customer has searched the desired services, retrieved the available schedules of all possible vendors from the central computer system, and decided which vendors to choose from. FIG. 10 shows a dashboard or APP on a network member's private device, which the network member can access service providers' information from the central computer system, and network member can also directly communicate with the particular service provider.

As shown in the FIGS. 2-2A, the customer forwards the appointment request for the desired time based on the available time slots directly to both the central system and service provider. Since service provider receives the requests from the customer directly without going through the central computer system, it improves the communication efficiency and prevents possible delay caused by the central computer system. The service provider then directly confirms the appointment with the customer, and forwards the confirmation to the central computer system.

As also shown in the FIGS. 2-2A, the service provider can either confirm or reject the requested appointment. Once the service provider confirms the requested appointment, the customer has to re-confirm and to accept the service provider's confirmation within predetermined period of time, a payment will then be withheld by a payment system at the same time the customer re-confirms the appointment. A payment withholding message will also be forwarded to both the central computer system and the service provider. Before a predetermined period of time before the appointment, for an example 24 hours, customer has the option to cancel or postpone the appointment.

At each of the appointment starting time and ending time, the service provider will forward a starting message and an ending message to the central computer system for logging the task status and completion. If the service is to be performed at the customer's premises, in one of the embodiment, customer's private device will display the service provider's traveling position and estimated arrival time. Further, the central computer system will provide a verification scheme for the custom to verify and authenticate the service provider upon arrival. The verification scheme can be a passcode/password, image, or barcode that both service provider and customer must have matching ones. Further, if the passcode/password can also be used to access customer's premise (unlock the door) if customer is not at the premises.

During the service, the scope of the service may be expanded as needed. If the scope of service is in need for expansion, service provider can login the scope change into the central computer system for record and for billing purpose. Once the appointment is completed and verified by the customer, the customer then submits the payment completion to release payment previously withheld by the payment system. The payment will either directly go into the service provider's account linked with the payment system, or the payment will be made to the central computer system, and then central computer system forwards the fund to service provider. Or if the customer is not satisfied with the service, customer can also send a complaint and reject the payment, or request for a refund.

Also, once the appointment is completed, both the service provider and the customer can provide rating to each other relating to the service performed. In one embodiment of the present invention, after the vendor member completes the service, both the customer member and the vendor member confirm the complete of service electrically via their own private devices. The method further comprises includes providing a means that allows the customer member to rate the vendor members. If the customer member submits a good rating message, for example, three or more stars of total five stars, then a pre-payment holding by the electrical payment center can be released to the service provider/vendor member sooner or automatically.

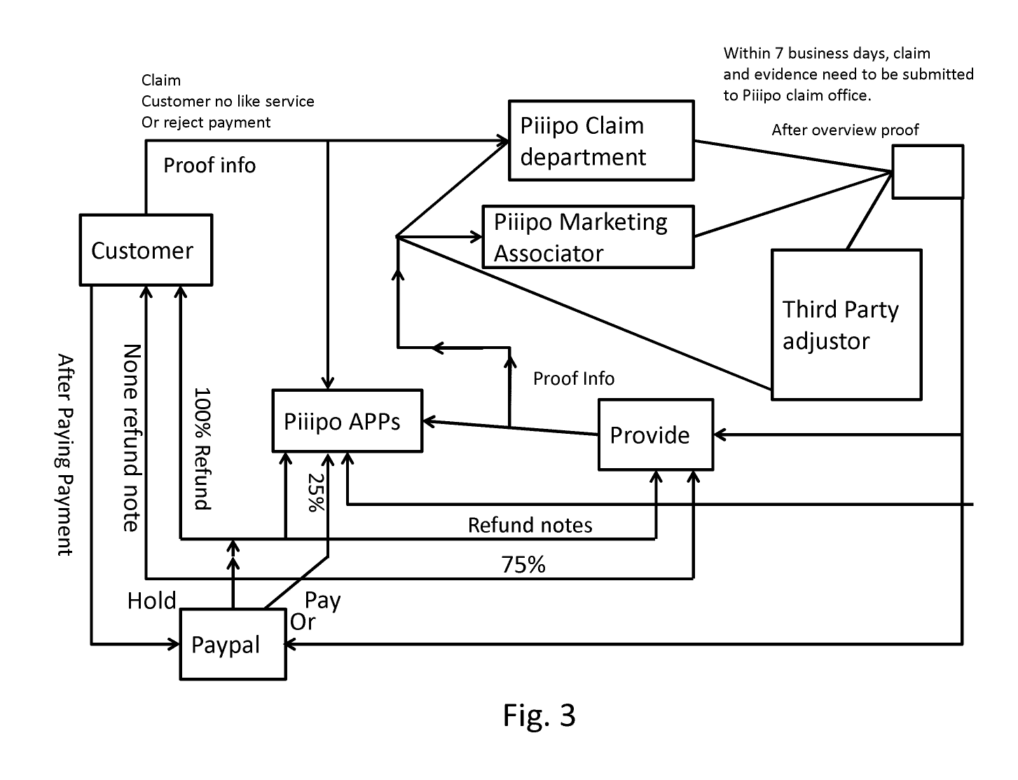

Please refer to FIG. 3. One of the embodiments of the method of the present invention further includes providing a means that allows the customer member to reject or refund payment if the payment is made by a mistake or the service received is not satisfied. When the customer member rejects payment, customer will provide necessary reasons or proof along with the payment rejection request. The customer then, via own private device, generates and sends a rejection request message directly to both the central computer system for logging and claim department for review.

The claim department will then review the request along with associated marketing associates and a third party adjuster along with feedback from the service provider before reaching the final decision. After the refund request is approved by the claim department and all reviewing parties, the decision will be forwarded to the payment system for refund, the service provider, the customer, and the central computer directly. Once the payment system receives the refund confirmation, the payment system will then cease or return the payment and sends a refund note electrically directly to the customer member's private device, the vendor member's private device, and the central computer system.

The method of one embodiment of the present invention comprises providing integrated managerial positions comprising a first-rank position, a second-rank position, and a third-rank position. The first-rank position can be called marketing associate, the second-rank position can be called general manager, and the third-rank position can be called director. According to an aspect of the present invention, the present invention further provides a system for facilitating the operations of the integrated managerial positions, such as performance tracking, bonus tracking, and mentoring activities.

According to an aspect of the present invention, the present invention provides a means for tracking production of each integrated managerial position whenever there is a transaction recorded by the central computer system, and the transaction either is done by that position holder or by a mentee mentored by the position holder. The production includes total sales/revenue and a number of supervised personnel. It can also include the number of referred membership the person brings into the network. Each rank of managerial positions has different requirements and benefits. The current system tracks the production of each person in order to calculate and evaluate each person's contribution and performance.

According to an aspect of the present invention, the present invention provides a means for tracking benefits and bonus for each of the integrated managerial position holders. In additional to the corporate benefit, such as health insurance and retirement plans, a managerial position holder is encouraged and rewarded by the bonus for production exceeding the minimum required threshold. The central computer system will calculate the bonus based on the production recorded under each managerial position holder's account. The production can either be the revenue generated, the number of services performed, or combination of the two. The first bonus is based on position holder's performed production. The second bonus is based on position holder's whole team's total performed production, including both mentor and mentee's production. The third bonus is based on leadership bonus, which is based on the mentee's production alone.

In addition, the system also tracks the service quality by reviewing the records of complaints and service providers' ratings from customers, and issues periodical recognitions to each qualified service provider. Also, the system will track the leadership recognition, which tracks the number of referees the position holder brings into the network, and also tracks the number in of mentees that position holder is currently mentoring. Accordingly, a leadership recognition reward can be issued periodically based on the record.

According to an aspect of the present invention, the present invention provides a mentoring means for facilitating the mentoring process. A person in any managerial position will be mentored by another person at a higher managerial position. The mentor can be the referrer who brought the person into the network, or the mentor can be assigned or choose by a mutual agreement between any two members. The mentor assists the mentee in handling the business transaction and resolving any disputes, thus the mentee can improve customer satisfaction and increase business success rate. As discussed above, the mentor as a related business associate will directly involve in any refund request from customers. By directly participating in this process, the mentor not only assists in improving customer satisfaction, the mentor also assists the mentee/service provider to resolve any dispute and improve over all mentee's service quality.

The system provides a platform for mentors and mentee communicating and discussing any matter. The system also forwards any customer concerns or complains in regard the mentee to the mentor. The system provides a direct communication channel between the mentee and mentor. Any communication is also forwarded to the mentor's mentor. For instance, when a complaint is filed against a mentee on the central computer system, the central computer system will forward the complaint to both the mentor and mentor's mentor. Such that, mentee will be assisted by two different levels of mentors for accelerating the mentoring process.

The advantages of the present invention is that the speed of the operating a task placement is faster, because the method forwarding an appointment request for said first task directly to both said central computer system and said first private device from said third device and forwarding an acceptance confirmation directly to both said central computer and said third private device from said first private device.

The above description is a preferred embodiment of the invention and it should be noted that it will be apparent to those skilled in the art that a number of improvements and modifications may be made without departing from the principles of the invention. These improvements and modifications also regarded as the scope of protection of the invention.

What is claimed is:

1. A professional service referring system for exchanging referring information between a central computer system and individual controlled private devices, said professional service referring system comprising:
providing a Three-Role-in-One architecture comprising of a customer role, a vendor role, and a managerial role, wherein each role has a preferred language, each system member has all three roles, and wherein a vendor member has an assigned junior managerial member, each junior managerial member has an assigned senior managerial member, each vendor member is managed by the assigned junior managerial member for improving business marketing and customer service, and the vendor member and the assigned junior managerial member provides different professional services to customer members, hence said system provides referrals, professional services, and a managerial operation scheme within locality;
providing a business transaction scheme executed by said central computer system and individual controlled devices; and
providing the managerial operation scheme for managing said managerial role executed by said central computer system, comprising:
tracking production of each junior managerial member and each senior managerial member, wherein said production is a total sales of each junior managerial member or each senior managerial member, or a combined sales of junior managerial member and assigned vendor member;
tracking number of referrals to each vendor member;
sending complaints against the assigned vendor member to the junior managerial member, wherein the junior managerial member is to assist resolving dispute and to improve customer service quality; and
tracking total complaints under each junior managerial member, senior managerial member, and each vendor member, wherein said central computer system signals for issuing quality recognition when said total complaints is within a predetermined complaint threshold, and calculating benefits for each junior managerial member and senior managerial member based on said quality recognition.

2. The professional service referring system of claim 1, further comprising:
providing a task assigning scheme, executed by a first private device of a first vendor member with a first available serving schedule, said second private device of a second vendor member with a second available serving schedule, said third private device for a first customer member, and said central computer system, wherein
said central computer system forwards a first available serving schedule and said second available serving schedule to said third private device upon a request for a first task with a preferred language;
said third private device sends directly a request for an appointment reservation for said first task to both said central computer system and said first private device; and
said first private device sends directly an acceptance confirmation or a rejection message to both said central computer and said third private device.

3. The professional service referring system of claim 2, wherein said third private device is a cellular phone, and said first private device is a desktop computer.

4. The professional service referring system of claim 2, wherein said vendor membership type further comprises a premium vendor membership and a regular vendor membership.

5. The professional service referring system of claim 4, wherein said first vendor member is in said premium vendor membership, and said first vendor member has a visual effect display as shown on a map.

6. The professional service referring system of claim 4, wherein said second vendor member is in said regular vendor membership, and said second vendor member is displayed on a map after a predetermined delay time.

7. The professional service referring system of claim 2, wherein when said first vendor member and said second vendor member are displayed on a map when they are within locality from said first customer member.

8. The professional service referring system of claim 2, wherein when said first customer member creates said first task, said third private device displays a map illustrating locations of both said first vendor member and said second vendor member.

9. The professional service referring system of claim 2, further comprises an interface for transferring said first available serving schedule from a first private system operating on said first private device.

10. The professional service referring system of claim 2, further comprises a means for filing a complaint from said third private device to said central computer system in regard said first task, wherein said central computer system forward said complaint to both said first vendor member and a manager corresponding junior managerial member.

11. The professional service referring system of claim 2, further comprises a means for points accumulation, wherein network members gain a number of points for performing activities, and the activities includes referring new network members, providing service, or purchasing services.

12. The professional service referring system of claim 11, further comprises a means for points redemption, wherein network members redeem points to said central computer system for rewards.

13. The professional service referring system of claim 11, further comprises a means for points forwarding, wherein a first network member forwards points to a second network member.

14. The professional service referring system of claim 1, further comprising:
generating a final available serving schedule for a first vendor member by said central computer system, where said first vendor member transmits a first available serving schedule for providing a first service, a second available serving schedule for providing a second service, and a personal schedule to said central computer system, and said central computer system generates a final available serving schedule of said first vendor member.

15. The professional service referring system of claim 2, further comprising:
said third private device sends a request for changing appointment time or a request for cancelling appointment, when said first customer member decides to change or to cancel said appointment reservation, directly to both said central computer and said first private device before a predetermined period of time before said appointment reservation.

16. The professional service referring system of claim 15, further comprising:
said first private device sends directly a starting message to said central computer system and said third private device to indicate beginning proceeding said task.

17. The professional service referring system of claim 15, further comprising:
said third private device displays said first vendor member's current location and an estimated arrival time when said first task is performed at said first customer member's premises; and
said central computer system provides a security scheme to said third device and said first device to authenticate said first vendor member when said first vendor member arrives at said first customer member's premises.

18. The professional service referring system of claim 15, further comprising:
said first private device sends a service scope modification on said first task to said central computer and said third private device when both said first customer member and said first vendor member agree and decide to change scope of said task;
said first private device sends directly a completing message to said central computer system and said third private device to indicate completing said task; and
said third private device sends a confirmed completion massage directly to said payment system to release said withheld payment, or sends a complaint directly to said central computer system and a payment system for requesting refund or rejecting payment.

19. The professional service referring system of claim 18, further comprising:
said first private device sends a customer ranking message to said central computer system for ranking said first customer member; and
said third private device send a vendor ranking message to said central computer system for ranking said first vendor member.
